(19) United States
(12) Patent Application Publication
(10) Pub. No.: US 2017/0311005 A1
(43) Pub. Date: Oct. 26, 2017

(54) METHOD OF WIRELESS AUDIO TRANSMISSION AND PLAYBACK

(71) Applicants: Szu-Tung LIN, Tainan City (TW); SATRIZON TECHNOLOGY CORP., Tainan City (TW)

(72) Inventor: Szu-Tung LIN, Tainan City (TW)

(21) Appl. No.: 15/496,877

(22) Filed: Apr. 25, 2017

(30) Foreign Application Priority Data
Apr. 26, 2016 (TW) 105112940
Apr. 26, 2016 (TW) 105112941

(51) Int. Cl. H04N 21/233; G10L 19/16; G11B 20/10

(52) U.S. Cl. CPC H04N 21/233; G10L 19/167; G11B 2020/10833; H04R 2420/07; H04R 2227/005

(57) ABSTRACT

A method of wireless audio transmission and playback includes steps of: a) dividing, by a host, the audio data into audio segments; b) transmitting, by the host, the audio segments to each of audio playback devices; c) transmitting to the host, by each of the audio playback devices, with respect to each of the audio segments received thereby, an acknowledgment indicating that the audio playback device has received the audio segment; and d) when determining, by the host based on the acknowledgment(s) thus received, that at least one of the audio playback devices has received a first specific audio segment, controlling all of the audio playback devices having received the first audio segment to play the first audio segment synchronously with each other.

### CROSS-REFERENCE TO RELATED APPLICATION

This application claims priority of Taiwanese Patent Application Nos. 105112940 and 105112941, both filed on Apr. 26, 2016.

### FIELD

The disclosure relates to a method of audio transmission and playback, and more particularly to a method of wireless audio transmission for synchronous playback.

### BACKGROUND

To alleviate issues caused by excessive physical wires between an audio source device and a plurality of speakers, methods of wireless communication, such as Wi-Fi technology, have been developed and widely applied in audio data transmission therebetween. However, synchronization of playback of the audio data among the plurality of the speakers is still an issue to be considered.

### SUMMARY

Therefore, an object of the disclosure is to provide a method of wireless audio transmission and playback that ensures synchronization of playback by multiple audio playback devices.

According to the disclosure, the method is to be implemented by a system which includes a host and a plurality of audio playback devices. The host stores audio data and is capable of communicating with each of the audio playback devices via wireless communication.

In one aspect of this disclosure, the method includes steps of:
a) dividing, by the host, the audio data into a plurality of audio segments;
b) transmitting, by the host, the plurality of audio segments to each of the audio playback devices;
c) transmitting to the host, by each of the audio playback devices, with respect to each of the audio segments received thereby, an acknowledgment which corresponds to the audio segment and which indicates that the audio playback device has received the audio segment; and
d) when it is determined, by the host based on the acknowledgment(s) thus received, that at least one of the audio playback devices has received a first specific audio segment which is indicated by one of the acknowledgement(s) as the audio segment received by said at least one of the audio playback devices, controlling, by the host, all of the audio playback devices that have received the first specific audio segment to play the first specific audio segment synchronously with each other.

In another aspect of this disclosure, the method includes steps of:
A) dividing, by the host, the audio data into a plurality of audio segments;
B) transmitting, by the host, the plurality of audio segments to each of the audio playback devices;
C) transmitting, by the host, to each of the audio playback devices, a playback command for playing a specific audio segment of the plurality of audio segments; and
D) determining, by each of the audio playback devices when receiving the playback command for playing the specific audio segment, whether the specific audio segment has been received thereby, and playing the specific audio segment when it is determined that the audio playback device has received the specific audio segment.

### BRIEF DESCRIPTION OF THE DRAWINGS

Other features and advantages of the disclosure will become apparent in the following detailed description of the embodiments with reference to the accompanying drawings, of which:

FIG. 1 is a block diagram illustrating an embodiment of a system which implements a method of wireless audio transmission and playback according to the disclosure;

FIG. 2 is a flow chart illustrating a first embodiment of the method of wireless audio transmission and playback according to the disclosure;

FIG. 3 is a schematic diagram illustrating an example of audio segments divided by a host;

FIG. 4 is a schematic diagram illustrating an example of the audio segments stored in three audio playback devices;

FIG. 5 is a flow chart illustrating a second embodiment of the method of wireless audio transmission and playback;

FIG. 6 is a flow chart illustrating a third embodiment of the method of wireless audio transmission and playback;

FIG. 7 is a schematic diagram illustrating an example of the audio segments stored in three audio playback devices;

FIG. 8 is a schematic diagram illustrating an example of the audio segments stored in three audio playback devices; and

FIG. 9 is a schematic diagram illustrating another example of the audio segments stored in three audio playback devices.

### DETAILED DESCRIPTION

Before the disclosure is described in greater detail, it should be noted that where considered appropriate, reference numerals or terminal portions of reference numerals have been repeated among the figures to indicate corresponding or analogous elements, which may optionally have similar characteristics.

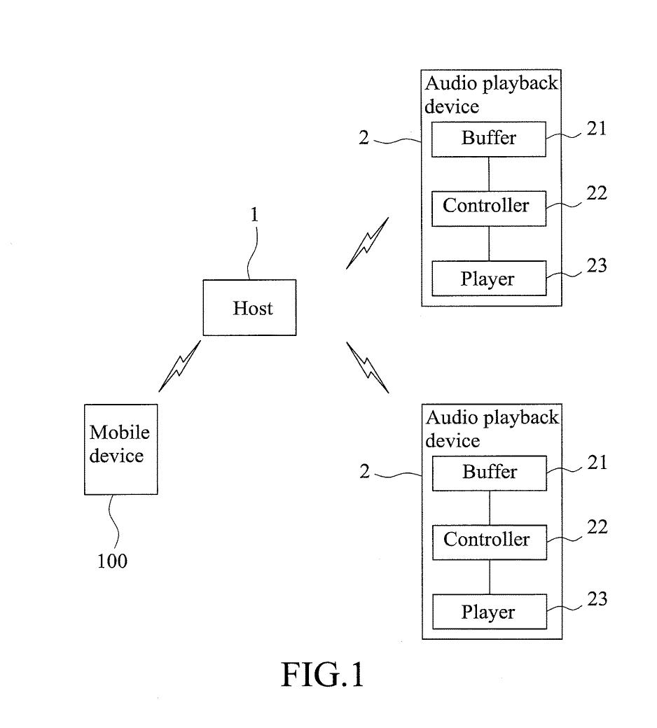

Referring to FIG. 1, an embodiment of a system which implements a method of wireless audio transmission and playback is illustrated. The system includes a host 1 and a plurality of audio playback devices 2. In this embodiment, the audio playback devices 2 are exemplified to be three in number, but are not limited thereto.

The host 1 is capable of communicating with each of the audio playback devices 2 via short-range wireless communication (e.g., through WiFi, Bluetooth, or some other technologies for wireless local area networking). The host 1 receives audio data from a mobile device 100 which stores the same, and stores the audio data thus received therein. Then, the host 1 divides the audio data into a plurality of audio segments so as to transmit the audio segments based on a streaming protocol. In this embodiment, the host 1 may be implemented by a computer or a mobile phone, but is not limited thereto.

Each of the audio playback devices 2 includes a buffer 21, a controller 22 and a player 23. The controller 22 is configured to wirelessly communicate with the host 1 via short-range wireless communication (e.g., through the technology for wireless local area networking), to receive the audio segments transmitted by the host 1, to store the audio segments thus received in the buffer 21, and to retrieve the audio segments from the buffer 21 so as to output the same to the player 23 for playback. In this embodiment, each of the audio playback devices 2 may be implemented by a wireless sound speaker, but is not limited thereto.

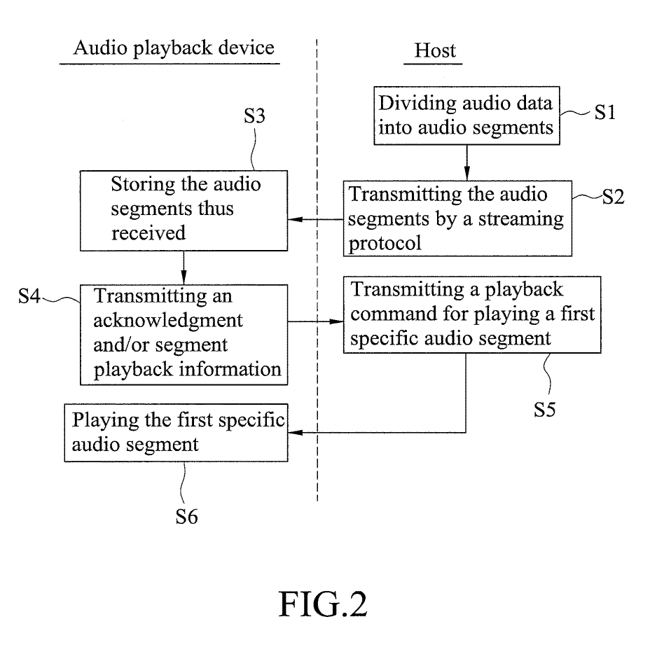

Referring to FIG. 2, a first embodiment of the method of wireless audio transmission and playback according to the disclosure is illustrated. The method includes steps S1 to S6.

In step S1, the host 1 receives the audio data from the mobile device 100, and divides the audio data into a plurality of audio segments. All of the audio segments have an identical time length, and each of the audio segments includes a unique serial number.

In step S2, the host 1 transmits the plurality of audio segments to each of the audio playback devices 2 by the streaming protocol.

In step S3, the controller 22 of each of the audio playback devices 2 that has received (parts or all of) the audio segments stores the audio segments thus received in the buffer 21 sequentially according to the serial numbers included in the corresponding audio segments.

In step S4, by each of the audio playback devices 2, with respect to each of the audio segments thus received, the audio playback device 2 transmits to the host 1 an acknowledgment which indicates the serial number of the audio segment and which indicates that the audio playback device 2 has received that particular audio segment. Moreover, in a condition that the playback devices 2 are currently playing the audio segments received from the host 1, each of the audio playback devices 2 that has received one of the audio segments, further transmits, at intervals of a predefined time period, to the host 1 during playing the one of the audio segments, segment playback information that is associated with the one of the audio segments being played. Specifically, the segment playback information may indicate which part of the one of the audio segments is being played. It should be note that the predefined time period is shorter than the time length of each of the audio segments.

In step S5, the host 1 receives the acknowledgements and the segment playback information. The host 1 determines, based on the acknowledgments thus received, that at least one of the audio playback devices 2 has received a first specific audio segment which is indicated by one of the acknowledgements as an audio segment received by said at least one of the audio playback devices 2. The host 1 further determines, based on the segment playback information, a time instant at which playback of the one of the audio segments being played is to be completed, wherein the first specific audio segment is one of the audio segments immediately posterior to the one of the audio segments being played by said at least one of the audio playback devices 2.

Next, the host 1 controls all of the audio playback devices 2 that have received the first specific audio segment to play the first specific audio segment synchronously with each other. Specifically speaking, after it is determined that at least one of the audio playback devices 2 has received the first specific audio segment based on the acknowledgments thus received, the host 1, at the time instant, transmits to each of the audio playback devices 2 that has received the first specific audio segment a playback command for playing the first specific audio segment, and refrains from transmitting the playback command for playing the first specific audio segment to each of the audio playback devices 2 that has not transmitted the corresponding acknowledgment.

In step S6, each of the audio playback devices 2 that has received the playback command for playing the first specific audio segment plays the first specific audio segment at the moment when receiving the playback command.

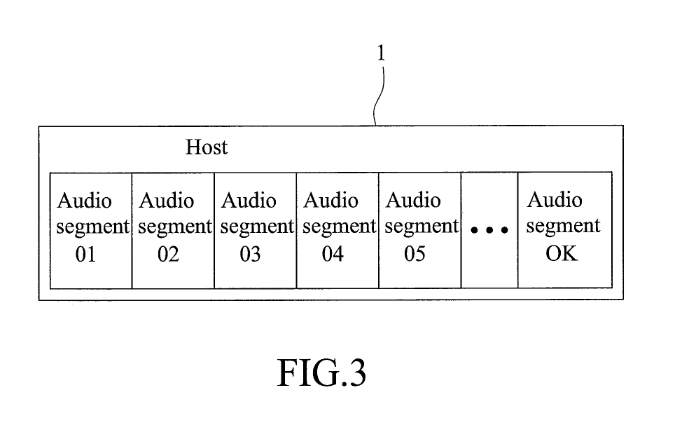

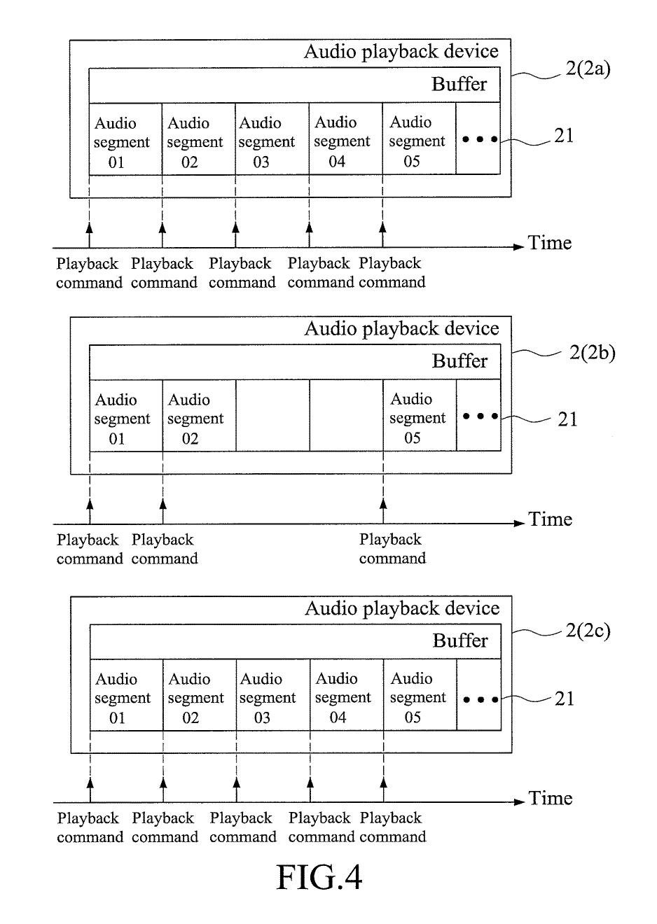

Take an instance shown in FIGS. 3 and 4 for explanation. As illustrated in FIG. 3, the host 1 divides the audio data into the plurality of audio segments each of which includes a unique serial number indicated as 01, 02 . . . or OK, where K is a positive integer. Furthermore, all of the audio segments have an identical time length of one second.

Each of the audio playback devices 2 that has received the one of the audio segments being played is configured to transmit the segment playback information at intervals of 0.1 seconds to the host 1. Referring to FIG. 4, at first, the host 1 determines, based on a standby notification, that each of the audio playback devices 2 is in the standby state. When the host 1 determines, based on the segment playback information thus received, that every single one of the audio playback devices 2 has received the audio segment whose serial number is indicated as 01 (i.e., an audio segment 01 as shown in FIGS. 3 and 4, and a similar naming convention is adopted in the following descriptions), the host 1 transmits simultaneously, to all of the audio playback devices 2 (that have received the audio segment 01), the playback command for playing the audio segment 01, such that each of the audio playback devices 2 that has received the playback command plays the audio segment 01 at the moment when receiving the playback command.

While the audio playback devices 2 are playing the audio segments 01 retrieved from their respective buffers 21, the host 1 determines, based on the segment playback information thus received, a first time instant at which playback of the audio segments 01 is to be completed, and determines, based on the acknowledgments thus received, that every single one of the audio playback devices 2 has received an audio segment 02 (i.e., the audio segment whose serial number is indicated as 02 as shown in FIGS. 3 and 4). Thereafter, the host 1 transmits, at the first time instant to each of the audio playback devices 2 (since the same has received the audio segment 02), a playback command for playing the audio segment 02, such that each of the audio playback devices 2 that has received the playback command plays the audio segment 02 at the first time instant.

While the audio playback devices 2 are playing the audio segments 02, the host 1 determines, based on the segment playback information thus received, a second time instant at which playback of the audio segments 02 is to be completed, and determines, based on the acknowledgments thus received, that only two of the audio playback devices 2 (i.e., the audio playback devices 2a and 2c) have received audio segment 03, i.e., the audio segment whose serial number is indicated as 03. Thereafter, the host 1 transmits, at the second time instant, only to each of the audio playback devices (2a and 2c) that has received the audio segment 03, a playback command for playing the audio segment 03, and refrains from transmitting the playback command for playing the audio segment 03 to the audio playback device (2b), such that each of the audio playback devices (2a and 2c) that has received the playback command plays the audio segment 03 at the second time instant, while the audio playback device (2b) that has not received the playback command does not play any audio segment at the second time instant. As a result, an effect of synchronous playback in terms of the audio segment 03 by the audio playback devices (2a and 2c) is realized, and a situation of delayed playback of the audio segment 03 that may otherwise result from waiting for the audio playback device (2b) to also receive the audio segment 03 is avoided.

In a similar fashion, the host 1 determines that an audio segment 04 is only received by the audio playback devices (2a, 2c), the host 1 transmits the playback command for playing the audio segment 04 only to these two audio playback devices (2a, 2c) at a third time instant at which playback of the audio segments 03 is determined to be completed, such that only the audio playback devices (2a, 2c), but not the audio playback device (2b), start to play the audio segments 04 retrieved from their respective buffers 21 at the third time instant.

Then, while the audio segment 04 is being played (by the audio playback devices (2a, 2c)), the host 1 determines, based on the segment playback information thus received, a fourth time instant at which playback of the audio segments 04 is to be completed, and determines, based on the acknowledgments thus received, that every single one of the audio playback devices 2 has received an audio segment 05 (i.e., the audio segment whose serial number is indicated as 05). Thereafter, the host 1 transmits, at the fourth time instant to each of the audio playback devices 2 having received the audio segment 05, a playback command for playing the audio segment 05, such that each of the audio playback devices 2 that has received the playback command plays the audio segment 05 at the fourth time instant.

In some embodiments, the audio playback devices 2 do not transmit the segment playback information to the host 1 at intervals of the predefined time period; instead, each of the audio playback devices 2 transmits the segment playback information to the host 1 only at a specific time point during the playing thereby of one of the audio segments, e.g., at the beginning of playing the one of the audio segments. Since all of the audio segments have an identical time length, the host 1 is able to determine a time instant at which playback of the one of the audio segments is to be completed.

In some embodiments, another approach of synchronization may be taken in which transmission of the segment playback information may be omitted. For example, timers (not shown) for all the audio playback devices 2 are implemented to be kept synchronized so that all of the audio playback devices 2 are caused to agree in time. In step S1, each of the audio segments further includes a timestamp containing a start playing time for the audio segment . Since the timestamp is widely utilized in techniques of streaming media and is familiar to people who are skilled in the art, details thereof will be omitted herein. In step S5, when the host 1 determines, based on the acknowledgments thus received, which of the audio playback devices 2 has received the first specific audio segment, the host 1 transmits the playback command for playing the first specific audio segment to each of the audio playback devices 2 that has received the first specific audio segment. In step S6, each of the audio playback devices 2 that has received the first specific audio segment plays the first specific audio segment according to the timestamp included in the first specific audio segment with reference to the timer after receiving the playback command.

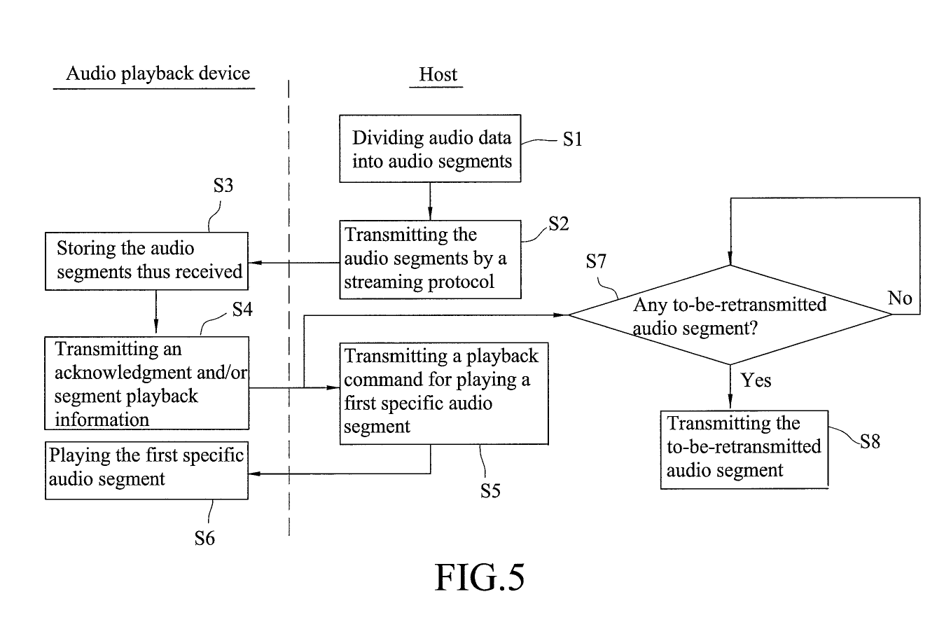

Referring to FIG. 5, a second embodiment of the method of wireless audio transmission and playback according to the disclosure is illustrated. In this embodiment, the method further includes steps S7 and S8 that implement a mechanism of retransmission.

In step S7, the host 1 makes a determination, based on the acknowledgments thus received, as to whether there is a to-be-retransmitted audio segment, which is one of the audio segments that is not received by one of the audio playback devices 2. The determination as to whether there is the to-be-retransmitted audio segment may be implemented by different approaches. Step S7 is repeated when a result of the determination is negative. Meanwhile, the host 1 identifies the to-be-retransmitted audio segment and a target audio playback device, which is said one of the audio playback devices 2 that has not received said one of the audio segments.

To give one example, the host 1 determines that a second specific audio segment of the audio segments is the to-be-retransmitted audio segment when the host 1 determines based on the acknowledgements that a ratio of a number of the audio playback devices 2 having obtained the second specific audio segment to a total number of the audio playback devices 2 has reached a predetermined threshold value (e.g., the ratio is greater than ½), and that at least one of the audio playback devices 2 has not yet obtained the second specific audio segment.

To give another example, the host 1 determines that a third specific audio segment of the audio segments is the to-be-retransmitted audio segments when the host 1 determines, based on the acknowledgment received from one of the audio playback devices 2, that the one of audio playback devices 2 has received a fourth specific audio segment of the audio segments that has the serial number posterior to the serial number of the third specific audio segment, and that the one of audio playback devices 2 has not yet received the third specific audio segment.

When the result of the determination made in step S7 is affirmative, the flow goes to step S8, where the host 1 transmits the to-be-retransmitted audio segment to the target audio playback device, so that the target audio playback device transmits the acknowledgement corresponding to the to-be-retransmitted audio segment to the host 1 after receiving the to-be-retransmitted audio segment.

The aforementioned mechanism of retransmission will be explained with reference to FIGS. 3 and 4. When the former example of retransmission is implemented, when the audio segment 01 is being played, the host 1 determines that the audio segment 03 is the to-be-retransmitted audio segment when the host 1 determines that two of the audio playback devices 2, i.e., the audio playback segments (2a and 2c) have received the audio segment 03 while the audio playback device (2b) has not received the audio segment 03 based on the acknowledgements thus received. When the latter example of retransmission is implemented, the host 1 determines that the audio segment 03 is the to-be-retransmitted audio segment when the host 1 determines that the audio playback device (2b) has received the audio segment 05 but has not yet received the audio segment 03 based on the acknowledgements thus received. By the above-mentioned mechanism of retransmission, if the audio segment 03 is not lost during a process of retransmission, the audio playback device (2b) would be able to receive the audio segment 03 thus retransmitted prior to playback of the audio segment 02 is completed, so that all of the audio playback devices 2 are capable of playing the audio segment 03 synchronously with each other.

Therefore, the aforementioned mechanism of retransmission may mitigate the possible occurrences of an issue that a specific one of the audio segments cannot be synchronously played by all of the audio playback devices 2 because at least one of the audio playback devices is not in receipt of the specific one of the audio segments.

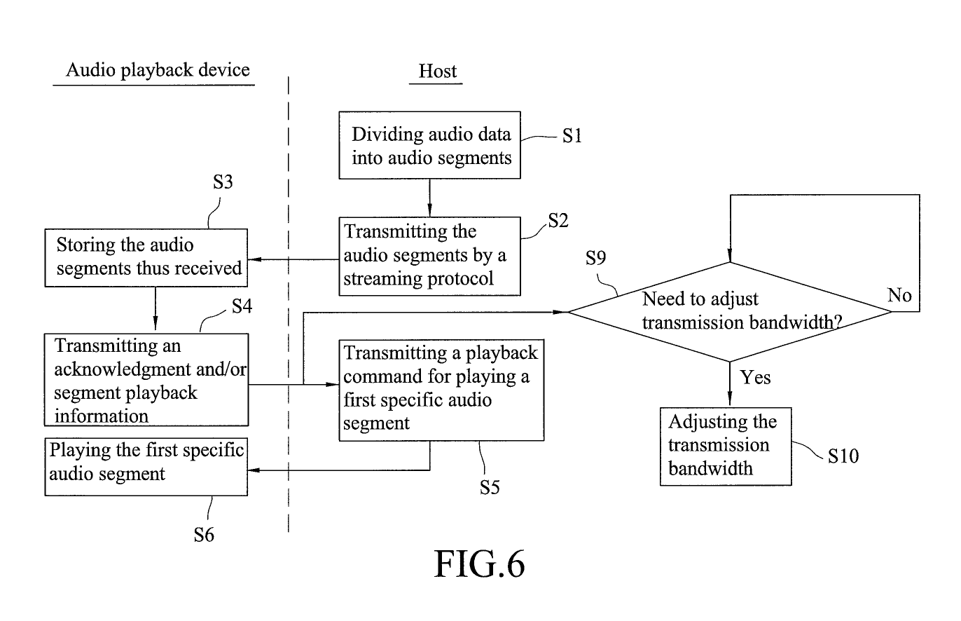

Referring to FIG. 6, a third embodiment of the method of wireless audio transmission and playback according to the disclosure is illustrated. In this embodiment, the method further includes, in comparison with the first embodiment, steps S9 and S10 that implement a mechanism of adjusting transmission bandwidth.

In step S9, the host 1 determines, based on the acknowledgements received within a preset time period (e.g., 0.5 seconds), whether a current reception bandwidth of a first audio playback device of the audio playback devices 2 is faster than that of a second audio playback device of the audio playback devices 2. Step S9 is performed once again for the acknowledgements received within a next session (i.e., next 0.5 seconds) when a result of the determination is negative.

When it is determined that the current reception bandwidth of the first audio playback device of the audio playback devices 2 is faster than that of the second audio playback device of the audio playback devices 2, the process goes to step S10, where the host 1 transmits to the first audio playback device, at a first transmission bandwidth, a portion of the audio segments that is not yet received by the first audio playback device, and transmits to the second audio playback device, at a second transmission bandwidth, a portion of the audio segments that is not yet received by the second audio playback device . It is worth to note that the second transmission bandwidth is faster than the first transmission bandwidth. For example, in this embodiment, a ratio of the second transmission bandwidth to the first transmission bandwidth is substantially equal to a ratio of the current reception bandwidth of the first audio playback device to that of the second audio playback device. However, implementation of the first and second transmission bandwidths may vary in other embodiments and is not limited to what is disclosed herein.

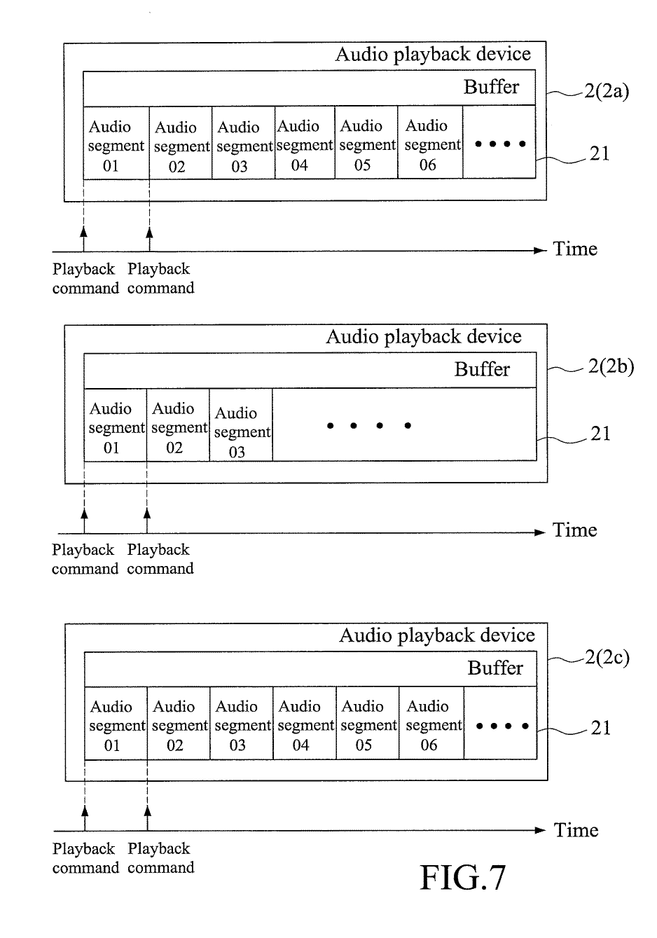

Referring to FIGS. 3 and 7 to 9, an explanation of implementation of the mechanism of adjusting transmission bandwidth is given hereinafter. As shown in FIG. 7, while the audio segments 02 are being played, the host 1 determines, based on the acknowledgements thus received, that the audio playback devices (2a and 2c) have received the audio segments 03-06 within the preset time period, and that the audio playback devices (2b) has received only the audio segment 03 within the preset time period. In other words, the current reception bandwidth of each of the audio playback devices (2a and 2c) is four times faster than that of the audio playback devices (2b). As a result, in the subsequent round of transmission of the audio segments, the host 1 transmits to the audio playback device (2a), at the first transmission bandwidth, a portion of the audio segments that is not yet received by the audio playback device (2a), transmits to the audio playback device (2c), at the first transmission bandwidth, the portion of the audio segments that is not yet received by the audio playback device (2c), and transmits to the audio playback device (2b), at the second transmission bandwidth, a portion of the audio segments that is not yet received by the audio playback device (2b), wherein the second transmission bandwidth is four times faster than the first transmission bandwidth. Consequently, the host 1 transmits the audio segments 04-07 to the audio playback device (2b), and transmits only the audio segment 07 to each of the audio playback devices (2a and 2c).

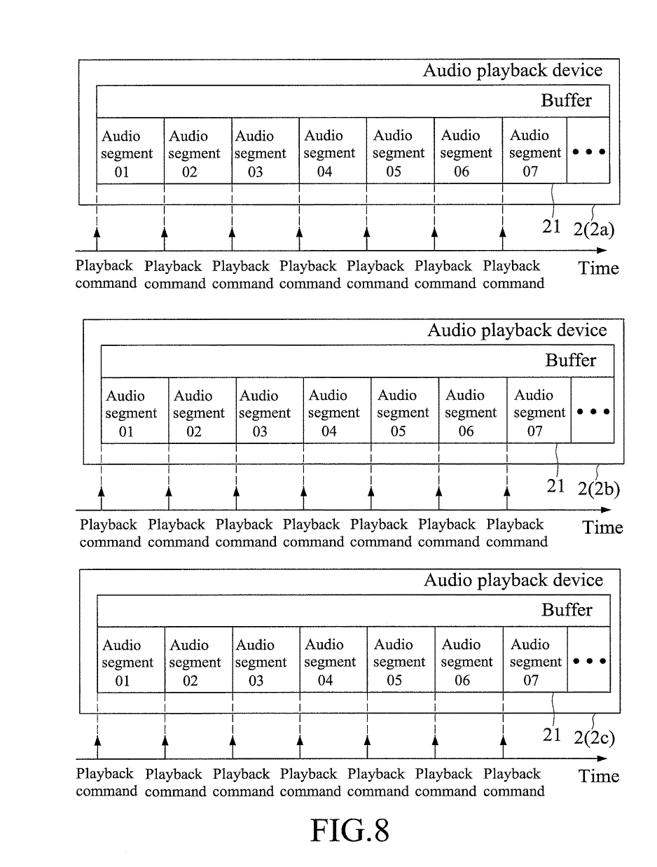

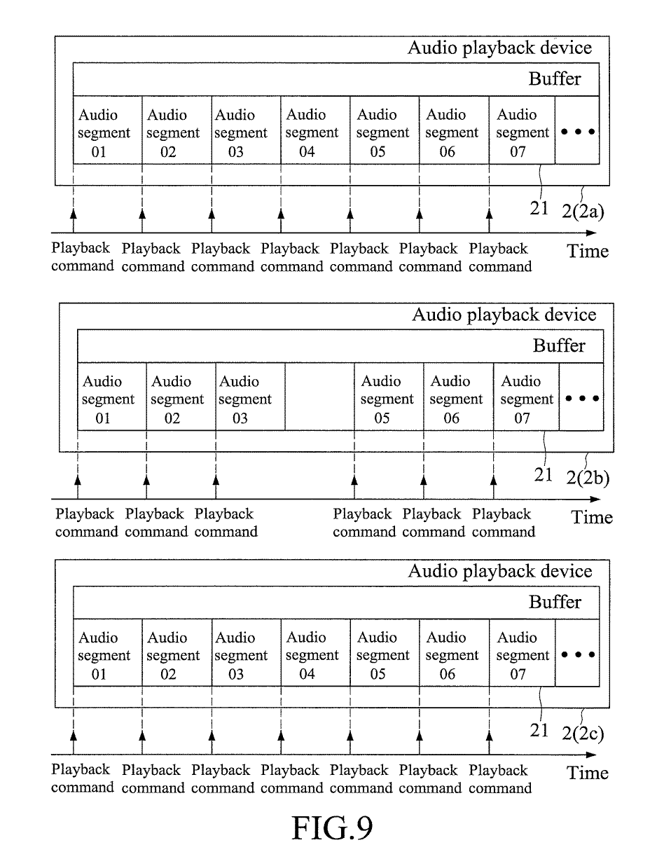

Therefore, as shown in FIG. 8, if none of the audio segments is lost in the above-mentioned subsequent round of transmission of the audio segments, while the audio segment 03 is being played, the audio playback devices (2a, 2b, 2c) should all have stored the audio segments 04-07 in their respective buffers 21 and are able to play the same subsequently and synchronously with each other. On the other hand, if some of the audio segments are lost in the above-mentioned subsequent round of transmission of the audio segments, such as the situation shown in FIG. 9, where the audio playback device (2b) has received the audio segments 05-07 but not the audio segment 04, the host 1 may transmit, at the time instant when playback of the audio segments 03 is to be completed, a playback command for playing the audio segment 04 to each of the audio playback devices (2a and 2c), so as to enable each of the audio playback devices (2a and 2c) to play the audio segment 04 . Also, the host 1 refrains from transmitting the playback command for playing the audio segment 04 to the audio playback device (2b) at said time instant. When playback of the audio segments 04 by the audio playback devices (2a and 2c) is completed, the host 1 transmits the palyback command for playing the audio segments 05-07 at respective time instances to all of the audio playback devices (2a, 2b, 2c) so that the same play subsequently the audio segments 05-07 in sync with each other.

It is worth noting that, the above-mentioned mechanism of adjusting transmission bandwidth may also mitigate the possible occurrences of the issue that a specific one of the audio segments cannot be synchronously played by all of the audio playback devices 2 because at least one of the audio playback devices 2 does not receive the specific one of the audio segments .

In addition, implementation of the mechanism of adjusting transmission bandwidth is not limited to what is previously described. For example, referring to FIGS. 3 and 7, when the host 1 determines that the transmission bandwidths between the host 1 and each of the audio playback devices 2 need to be adjusted, the host 1 temporarily refrains from transmitting the audio segments to each of the audio playback devices (2a and 2c), and temporarily extends the transmission bandwidth between the host 1 and the audio playback device (2b). When the host 1 determines later that the audio playback device (2b) has received the audio segments 04-06, the host 1 recovers the transmission of the audio segments between the host 1 and each of the audio playback devices (2a and 2c).

In a fourth embodiment of the method of wireless audio transmission and playback according to the disclosure, each of the audio playback devices 2 does not transmit, after receiving one of the audio segments, to the host 1 the acknowledgement corresponding to the one of the audio segments thus received. In addition, with respect to each of the playback devices 2, after having transmitted the audio segments to the audio playback device 2 for a while by the streaming protocol, the host 1 sequentially transmits to the audio playback device 2, based on the segment playback information thus received from the audio playback device 2, playback commands for playing the audio segments that have been indicated as having been received by the audio playback device 2. Each of the audio playback devices 2 determines, when receiving one of the playback commands, whether a corresponding one of the audio segments has been received, and plays the corresponding one of the audio segments when it is determined that the corresponding one of the audio segments has been received thereby.

Again, reference is made to FIGS. 3 and 4 for explanation by way of an example. After having transmitted the audio segments to each of the audio playback devices 2 for a while, the host 1 determines that the audio playback devices 2 should normally have all received a portion of the audio segments, and consequently transmits to each of the audio playback devices 2 the playback command for playing the audio segment 01 so as to enable the audio playback device 2 to play the audio segment 01. Each of the audio playback devices 2 determines, when receiving the playback command for playing the audio segment 01, whether the audio segment 01 has been received, and plays the audio segment 01 when it is determined that the audio segment 01 has been received. At the same time, each of the audio playback devices 2 transmits, to the host 1, the segment playback information that is associated with the playback of the audio segment 01 being played.

While the audio segments 01 are being played by those of the audio playback devices 2 in receipt of the same, the host 1 determines, based on the segment playback information thus received, a time instant at which playback of the audio segment 01 is to be completed, and transmits the playback command for playing the audio segment 02 to each of the audio playback devices 2 at the time instant, such that each of the audio playback devices 2 is enabled to play the audio segment 02 at the time instant should it determine that it is in receipt of the audio segment 02. Meanwhile, each of the audio playback devices 2 transmits to the host 1 the segment playback information that is associated with playback of the audio segment 02 being played. It is worth to note that since any discrepancy between the time for transmitting the playback command and the time for determining whether the audio segment 02 has been received is insignificantly small, playback of the audio segment 02 may be deemed to occur right at the time instant when playback of the audio segment 01 is completed and when the playback command is transmitted by the host 1.

Similarly, while the audio segment 02 is being played, the host 1 determines, based on the segment playback information thus received, another time instant at which playback of the audio segment 02 is to be completed, and transmits to each of the audio playback devices 2 at the another time instant the playback command for playing the audio segment 03. After receiving the playback command for playing the audio segment 03, the audio playback devices (2a and 2c) plays the audio segment 03 at the another time instant for it is determined by each of the same that the audio segment 03 has been received. However, even though the audio playback device (2b) has received the playback command for playing the audio segment 03, the audio playback device (2b) does not play the audio segment 03 at the another time instant because it is determined that the audio playback device (2b) did not receive the audio segment 03.

In summary, the method of wireless audio transmission and playback of this disclosure is to be implemented by the system which includes the host and the audio playback devices. The host divides the audio data into the audio segments, and transmits the audio segments to each of the audio playback devices by the streaming protocol. For each of the audio segments, the host transmits, according to the acknowledgments and/or the segment playback information received from the audio playback device, the corresponding playback command so as to control all audio playback devices that have received the audio segment to play the audio segment synchronously. Moreover, the method of this disclosure enables the host to dynamically retransmit one or more audio segments based on the acknowledgments to each of the audio playback devices as needed, and/or to dynamically adjust the transmission bandwidth thereof for each audio playback device based on the acknowledgments.

In the description above, for the purposes of explanation, numerous specific details have been set forth in order to provide a thorough understanding of the embodiments. It will be apparent, however, to one skilled in the art, that one or more other embodiments may be practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects.

While the disclosure has been described in connection with what are considered the exemplary embodiments, it is understood that this disclosure is not limited to the disclosed embodiments but is intended to cover various arrangements included within the spirit and scope of the broadest interpretation so as to encompass all such modifications and equivalent arrangements.

What is claimed is:

1. A method of wireless audio transmission and playback, to be implemented by a system which includes a host and a plurality of audio playback devices, the host storing audio data and being capable of communicating with each of the audio playback devices via wireless communication, the method comprising steps of:
a) dividing, by the host, the audio data into a plurality of audio segments;
b) transmitting, by the host, the plurality of audio segments to each of the audio playback devices;
c) transmitting to the host, by each of the audio playback devices, with respect to each of the audio segments received thereby, an acknowledgment which corresponds to the audio segment and which indicates that the audio playback device has received the audio segment; and
d) when it is determined by the host based on the acknowledgment(s) thus received that at least one of the audio playback devices has received a first specific audio segment which is indicated by one of the acknowledgement(s) as the audio segment received by said at least one of the audio playback devices, controlling, by the host, all of the audio playback devices that have received the first specific audio segment to play the first specific audio segment synchronously with each other.

2. The method as claimed in claim 1, wherein step d) includes transmitting, by the host when it is determined that at least one of the audio playback devices has received the first specific audio segment based on the acknowledgment(s) thus received, to each of the audio playback devices that has received the first specific audio segment a playback command for playing the first specific audio segment, such that each of the audio playback devices that has received the playback command for playing the first specific audio segment plays the first specific audio segment.

3. The method as claimed in claim 2, wherein step d) includes refraining, by the host, from transmitting the playback command for playing the first specific audio segment to each of the audio playback devices that has not transmitted correspondingly the acknowledgment.

4. The method as claimed in claim 2, wherein:
in step a), each of the audio segments includes a unique serial number;
step c) includes transmitting, by each of the audio playback devices that has received one of the audio segments, to the host during playing the one of the audio segments, segment playback information that is associated with the one of the audio segments being played; and
step d) includes determining, by the host based on the segment playback information, a time instant at which playback of the current one of the audio segments is to be completed, and transmitting, at the time instant and to each of the audio playback devices that has received the first specific audio segment, the playback command for playing the first specific audio segment, the first specific audio segment being one of the audio segments immediately posterior to the current one of the audio segments being played by said at least one of the audio playback devices.

5. The method as claimed in claim 4, wherein:
in step a), all of the audio segments have an identical time length; and
step c) includes transmitting, by each of the audio playback devices that has received the one of the audio segments being played, the segment playback information at intervals of a predefined time period, which is shorter than the time length of the audio segments.

6. The method as claimed in claim 2, each of the audio playback devices including a timer, timers for all of the audio playback devices being kept synchronized, wherein:
in step a), each of the audio segments includes a timestamp containing a start playing time; and
step d) includes playing, by each of the audio playback devices having received the first specific audio segment, the first specific audio segment according to the time stamp included in the first specific audio segment with reference to the timer after receiving the playback command for playing the first specific audio segment.

7. The method as claimed in claim 1, further comprising steps of:
e) determining, by the host based on the acknowledgment(s) thus received, a to-be-retransmitted audio segment, which is one of the audio segments that is not received by one of the audio playback devices, and further determining a target audio playback device, which is the one of the audio playback devices that has not received said one of the audio segments; and
f) transmitting, by the host, the to-be-retransmitted audio segment to the target audio playback device.

8. The method as claimed in claim 7, wherein step e) includes determining, by the host, that a second specific audio segment of the audio segments is the to-be-retransmitted audio segment when the host determines based on the acknowledgement(s) that a ratio of a number of the audio playback devices having obtained the second specific audio segment to a total number of the audio playback devices has reached a predetermined threshold value, and that at least one of the audio playback devices has not yet obtained the second specific audio segment.

9. The method as claimed in claim 7, wherein:
in step a), each of the audio segments includes a unique serial number; and
step e) includes determining, by the host, that a third specific audio segment of the audio segments is the to-be-retransmitted audio segments when the host determines, based on the acknowledgment(s) received from one of the audio playback devices, that the one of audio playback devices has received a fourth specific audio segment of the audio segments that has the serial number posterior to the serial number of the third specific audio segment, and that the one of audio playback devices has not yet received the third specific audio segment.

10. The method as claimed in claim 1, further comprising a step of:
g) transmitting, by the host when the host determines based on the acknowledgement(s) received within a preset time period that a current reception bandwidth of a first audio playback device of the audio playback devices is faster than that of a second audio playback device of the audio playback devices, to the first audio playback device at a first transmission bandwidth, a portion of the audio segments that is not yet received by the first audio playback device, and transmitting, to the second audio playback device at a second transmission bandwidth, a portion of the audio segments that is not yet received by the second audio playback device, wherein the second transmission bandwidth is faster than the first transmission bandwidth.

11. The method as claimed in claim 10, wherein in step g), a ratio of the second transmission bandwidth to the first transmission bandwidth is substantially equal to a ratio of the current reception bandwidth of the first audio playback device to that of the second audio playback device.

12. The method as claimed in claim 1, wherein the host receives the audio data from a mobile device which stores the audio data, and stores the audio data therein.

13 . A method of wireless audio transmission and playback, to be implemented by a system which includes a host and a plurality of audio playback devices, the host storing audio data and being capable of communicating with each of the audio playback devices via wireless communication, the method comprising steps of:
A) dividing, by the host, the audio data into a plurality of audio segments;
B) transmitting, by the host, the plurality of audio segments to each of the audio playback devices;
C) transmitting, by the host, to each of the audio playback devices, a playback command for playing a first specific audio segment of the plurality of audio segments; and
D) determining, by each of the audio playback devices when receiving the playback command for playing the first specific audio segment, whether the first specific audio segment has been received thereby, and playing the first specific audio segment when it is determined that the audio playback device has received the first specific audio segment.

14. The method as claimed in claim 13, further comprising a step of E) transmitting, by each of the audio playback devices that has received one of the audio segments, to the host during playing the one of the audio segments, segment playback information that is associated with the one of the audio segments being played, wherein:
in step A), each of the audio segments includes a unique serial number; and
step C) includes determining, by the host based on the segment playback information, a time instant at which playback of the current one of the audio segments is to be completed, and transmitting the playback command for playing the first specific audio segment at the time instant, the first specific audio segment being one of the audio segments immediately posterior to the current one of the audio segments.

15. The method as claimed in claim 14, wherein:
in step A), all of the audio segments have an identical time length; and
step E) includes transmitting, by each of the audio playback devices that has received the one of the audio segments being played, the segment playback information at intervals of a predetermined time period, the predefined time period being shorter than the time length of the audio segments.

16. The method as claimed in claim 13, each of the audio playback devices including a timer, timers for all of the audio playback devices being kept synchronized, wherein:
in step A), each of the audio segments includes a timestamp containing a start playing time; and
step D) includes playing, by each of the audio playback devices having received the first specific audio segment, the first specific audio segment according to the timestamp included in the first specific audio segment with reference to the timer after receiving the playback command for playing the first specific audio segment.
